(19) United States
(12) Patent Application Publication
(10) Pub. No.: US 2012/0116986 A1
(43) Pub. Date: May 10, 2012

(54) System and Method for Integrating Medical Treatment Guidelines with Real-Time, Ad-Hoc, Community Generated Commentary to Facilitate Collaborative Evidence-Based Practice

(76) Inventor: Patricia Ault, Pasadena, TX (US)

(21) Appl. No.: 13/335,519

(22) Filed: Dec. 22, 2011

(51) Int. Cl. G06Q 99/00

(52) U.S. Cl. 705/319

(57) ABSTRACT

A system and method for automatically integrating real-time, ad-hoc, community generated commentary such as comments, notes, observations, and anecdotal data in any human perceptible form with medical treatment guidelines (otherwise known as “clinical guidelines”, “clinical protocols”, or “clinical practice guidelines”) to create a display that shows the medical treatment guideline alongside the commentary. The present invention employs a server with a database capable of receiving and displaying commentary from local or remote users via a network, such as the Internet using various terminal devices such as a computers, smartphones, or tablets. The present invention provides an accessible, dynamically revised stream of commentary thus creating an evolving resource in which infrequently revised medical treatment guidelines are supplemented with commentary in real-time. The utilization of medical treatment guidelines by health-care providers now characterized as “evidence based medicine” or “evidence based practice” is thus advanced constituting what is termed as “collaborative evidence-based practice.”

### CROSS-REFERENCE TO RELATED APPLICATIONS

Not Applicable.

### FIELD OF THE INVENTION

The present invention relates to a system and method for integrating real-time, ad-hoc, community generated commentary with medical treatment guidelines (otherwise known as “clinical guidelines”, “clinical protocols”, or “clinical practice guidelines”) to create a display that shows the medical treatment guideline alongside the commentary. More particularly, the present invention relates to a system and method that employs a database capable of receiving real-time, ad-hoc, community generated commentary such as notes, observations, and anecdotal data from local or remote locations and integrating this commentary in said database with an associated medical treatment guideline to generate a display containing the guideline enhanced by the commentary. As a result, this system and method provides a readily accessible, dynamically revised stream of commentary regarding a particular medical treatment guideline thus creating an evolving informational resource in which infrequently revised medical treatment guidelines are supplemented with real-time, ad-hoc, community generated commentary contributed by a wide variety of stakeholders in the health care ecosystem. The development and delivery of health care services using the system and method constitute what is known as “collaborative evidence-based practice.”

### BACKGROUND OF THE INVENTION

For many years, healthcare treatment costs have spiraled ever upwards. A large component of these ever increasing costs is associated with the utilization of non-standard or patently ineffective treatments to manage standardized, treatable maladies. As early as 1972, a need for a methodology incorporating standardized evidence-based practice to treat particular clinical conditions was identified. See: Archie Cochrane, M.D., Effectiveness and Efficiency: Random Reflections on Health Services (2d ed., Nuffield Provincial Hospitals Trust 1989). In his groundbreaking treatise, Cochrane argued for the application of hard scientific data (evidence) developed using the scientific method as the primary tool for elucidating the proper clinical response to any medical problem (practice).

Since then, the health care community has steadily moved towards a model in which virtually all aspects of evidence-based practice are informed by scientific evidence as encapsulated in a standardized medical treatment guidelines. In this model the data informing any guideline is developed using the scientific method. While there are numerous standards for evaluating the evidence used to construct a particular medical treatment guideline, most have as their highest grade some form of randomized controlled trial and, correspondingly, have as their lowest grade evidence derived from expert opinion, expert committees, and such. Unsurprisingly, the practices involved in obtaining data of the requisite high standards required to support a particular medical treatment guideline are necessarily in the province of the academic or clinical researcher because these experts have the greatest familiarity with the scientific method and the investigative principals that underlie it. Collectively, these experts constitute what today can be termed as the “academic side” of the health-care delivery ecosystem. In the rigid orthodoxy of the scientific method, data derived from sources not developed using the scientific method, i.e. anecdotal or observational data from patients, family members, third party payers, professional organizations, hospitals, educational institutions, public policy makers, and numerous other constituents of the health care ecosystem is strictly excluded.

Apart from the “academic side” stands the “clinical side” of the health-care ecosystem. These are the individuals who effectuate the medical treatment guidelines promulgated by the academic side. In terms of relative numbers there are, of course, far more constituents on the clinical side than on the academic side. Indeed, this divergence in numbers is rapidly accelerating. One reason is that entirely new areas of professional specialization are being created on the clinical side in response to an obvious need for highly-skilled, autonomous front-line health care providers. For example, traditionally the primary, hands-on caregiver in the health care environment was the Registered Nurse (RN). As treatment practices became more complex and the population of individuals requiring health care services multiplied, a new class of more highly-skilled, autonomous nurse was created: the Registered Nurse Practitioner (RNP). This trend has continued culminating with the arrival on the scene of the Doctor of Nurse Practice (DNP). While these (and other) classes of “bedside” health-care providers offer the great bulk of hands-on health care delivery, they play little or no direct role in the evolution of the medical treatment guidelines they are required to use daily. This is unfortunate because it is these front-line health-care providers who are best positioned to judge the real world effectiveness of the medical treatment guidelines they utilize every day.

Of course, the promulgation of medical treatment guidelines and the delivery of health care services based on those guidelines does not occur in a vacuum. Other stakeholders in the health care delivery ecosystem are affected by the activities of health-care academicians and clinicians. More specifically patients, families, third-party payers, professional organizations, hospitals, educational institutions, public policy makers, and numerous others have a real interest in the effective delivery of high quality, low cost health care services. Naturally, the Internet has empowered these other stakeholders to become increasingly more vocal and seek greater participation in health care planning, resource allocation, and in the actual delivery of health care services—including the promulgation of the medical treatment guidelines to which they, their family members, customers, political constituents, etc. will be subjected.

In the context of this tri-partite health care delivery model (with standards promulgating academicians on the first side, standards consuming clinicians on the second side, and patients, families, and other stakeholders aligned on the third side) a major flaw is exposed in the evidence-based practice model because medical treatment guidelines are promulgated by only one class of stakeholder (academicians) absent real-time, ad-hoc community generated input from constituents of the other two sides. In the example in FIG. 1, constituents of the academic side 100 unilaterally collect observational data 103 and 104 from constituents of the clinical side 101 and other healthcare delivery stakeholders 102, respectively. Thus, the only driver of new or revised medical treatment guidelines resulting in improved healthcare outcomes 105 are constituents of the academic side 100. Moreover, collected observational data 103 and 104 is assembled over a protracted period of time and new or revised medical treatment guidelines with their improved patient outcomes 105 are thus promulgated infrequently. In this model, based as it is in the scientific method, it is entirely reasonable that constituents of the academic side 100 should drive the collection of study data 103 and 104 and subsequent promulgation of medical treatment guidelines offering their improved patient outcomes 105. It is sub-optimal however that constituents of the academic side 100 should be the sole point of focus for changing and improving the guideline over time because the process is slow, in many cases taking years to unfold. As a result, once promulgated, a medical treatment guideline is a relatively static thing. The only change a particular medical treatment guideline undergoes occurs through the promulgation of an alternative, hopefully superior guideline. Even then, the new medical treatment guideline typically exists alongside the older, putatively less effective guideline, with some clinicians choosing to use the newer guideline and other clinicians choosing the older guideline. Unfortunately, there is no means for clinicians and other health care providers 101 to contribute observational and anecdotal data regarding the efficacy of a particular guideline in a particular clinical context after the guideline is promulgated. Similarly, there is no means for patients, families, and other stakeholders in the health-care delivery ecosystem 102 to contribute observational and anecdotal data regarding the efficacy of a particular medical treatment guideline in the clinical contexts in which they have an interest. Rather, it remains solely to constituents of the academic side 100 who promulgate the medical treatment guideline to slowly and methodically survey and study constituents of the other two sides of the health care delivery ecosystem 101 and 102 to ascertain the clinical efficacy of the particular guideline. This is highly inefficient.

Accordingly, a need exists for a system and method of integrating real-time, ad-hoc, community generated commentary including comments, notes, observations, and anecdotal data with a specific medical treatment guideline to provide an improved means of assessing the efficacy of a the guideline after it has been promulgated. Since the system and method provide a picture of the efficacy of a particular medical treatment guideline in real-time, it may inform future investigatory inquiries by academicians to more quickly create alternative guidelines.

### SUMMARY OF THE INVENTION

An object of the present invention is to provide a system and method of automatically integrating real-time, ad-hoc, community generated commentary including comments, notes, observations, and anecdotal data with a specific medical treatment guideline to generate a display containing both the guideline and the commentary.

A further object of the present invention is to provide a system and method that is capable of receiving real-time, ad-hoc, community generated commentary including comments, notes, observations, and anecdotal data from local or remote locations via a network such as the Internet. This community generated commentary may include comments, notes, observations, and anecdotal data in any human perceptible form including, but not limited to, textual, graphical, video, or aural forms, including but not limited to, documents, spreadsheets, presentations, animations, drawings, designs, DNA sequence listings, chemical formulae, photographs, video, audible recordings including recordings of human speech and the manual or automatic transcriptions thereof, and so on.

A further object of the present invention is to provide a system and method that is capable of prioritizing and categorizing received real-time, ad-hoc, community generated commentary including comments, notes, observations, and anecdotal data and displaying such prioritized and categorized data to community members via a variety of commonly available computational devices, including but not limited to, computers, smartphones, and pad computers. Real-time, ad-hoc, community generated commentary including comments, notes, observations, and anecdotal data may be prioritized and categorized by: 1) the educational level, if appropriate, of the submitting party; 2) the classification of the submitting party (e.g. academician versus clinician versus other stakeholder); 3) the area of medical specialization, if any, of the submitting party (e.g. oncology versus internal medicine); 4) the institutional affiliation, if any, of the submitting party; 5) the membership in an arbitrary or formal group, such as a research group, if any, of the submitting party; and/or, 6) by a diagnosis group classification such as a Diagnosis Related Group (DRG) number, an International Classification of Diseases (ICD) number, or a Major Diagnostic Categories (MDC) number.

A further object of the present invention is to provide a system and method that allows community members to self-police the real-time, ad-hoc, community generated commentary, by means of editing it or deleting it. The identity of the entity editing or deleting a particular community provided comment, note, observation, or piece of anecdotal data is maintained, so that all community members can readily ascertain the identity of the entity editing or deleting a particular community provided comment, note, observation, or piece of anecdotal data.

These and other objects are substantially achieved by providing a system and method of integrating medical treatment guidelines with real-time, ad-hoc, community generated commentary. The system and method each employ a data storage component, which is adapted to store medical treatment guidelines which are used to: 1) assess the condition of an entity; 2) take action on the entity; or, 3) both assess the condition of an entity and take action on the entity, and which is further adapted to store data representing at least one piece of community generated commentary regarding the guideline. The system and method further employ an output device, adapted to output a diagram representing the medical treatment guideline data and at least one piece of community generated commentary regarding the guideline. The diagram includes at least one component representing a relationship between at least a portion of the medical treatment guideline data and at least one piece of community generated commentary regarding the guideline. More specifically, the output device may include a display which is adapted to display the diagram or a printer which is adapted to print the diagram. Also, an entity may be: 1) an individual person; 2) a group of related persons, such as a family; or, 3) a group of unrelated individuals, such as might comprise a racial or ethnic group, a corporation, a sports team, and so on.

### BRIEF DESCRIPTION OF THE DRAWINGS

These and other objects, advantages, and novel features of the present invention will be more readily appreciated from the following detailed description of a preferred embodiment thereof when read in conjunction with the accompanying drawings, in which:

FIG. 1 is a conceptual block diagram illustrating an example of the information flow and resulting benefits that presently occur in the prior art when promulgating and using a medical practice guideline demonstrating the inefficiencies and sub-optimal patient outcomes that occur.

FIG. 2 is a conceptual block diagram illustrating an example of the information flow, and resulting benefits that occur when using a system and method of integrating real-time, ad-hoc, community generated commentary with medical treatment guidelines according to an embodiment of the present invention, thus demonstrating the efficiencies and improved patient outcomes that occur.

FIG. 3 is a conceptual block diagram illustrating an example of a network, such as the Internet, adapted for use with a system and method of integrating real-time, ad-hoc, community generated commentary with medical treatment guidelines according to an embodiment of the present invention; and,

FIG. 4 is smaller scale view showing the whole formed by partial views FIG. 4A and alternately FIG. 4B or FIG. 4C, so that when assembled as shown the combined views illustrate an example of a display that may be created on a workstation, computer, or other device connected to a network, such as the Internet, showing real-time, ad-hoc, community generated commentary integrated with medical treatment guidelines according to an embodiment of the present invention.

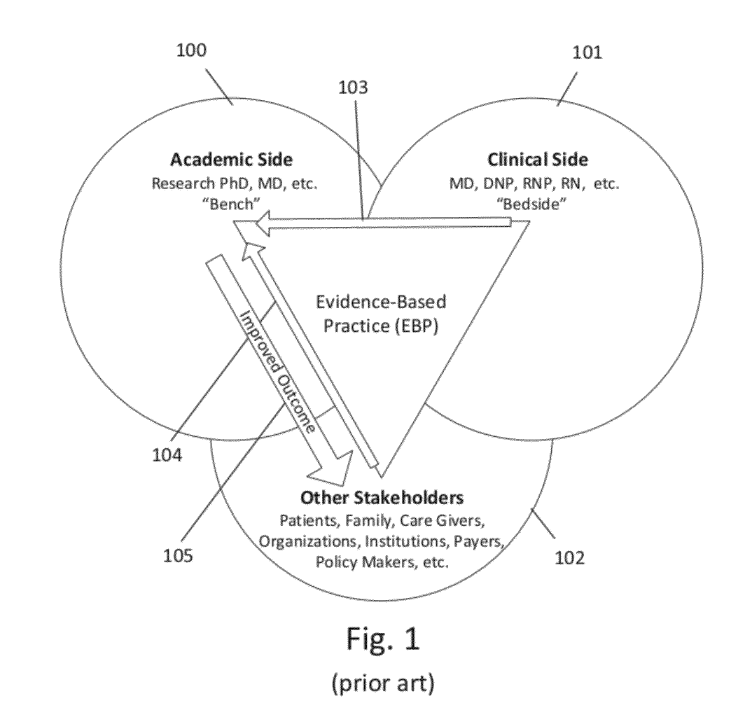

### DETAILED DESCRIPTION OF PREFERRED EMBODIMENT

The present disclosure can be described by the embodiments given below. It is understood, however, that these embodiments are not to be construed as limitations to present disclosure, but are used to described a particular implementation of the invention.

The present invention provides a system and method of automatically integrating real-time, ad-hoc, community generated commentary including comments, notes, observations, and anecdotal data with a specific medical treatment guideline to generate a display containing both the guideline and the commentary. It is understood, however, that the following disclosure provides many different embodiments, or examples, for implementing different features of the invention. Well known elements are presented without detailed description that might otherwise obscure the present invention in unnecessary detail. For the most part, details unnecessary to obtain a complete understanding of the present invention have been omitted insofar as such details are well within the skills of persons of ordinary skill in the relevant art.

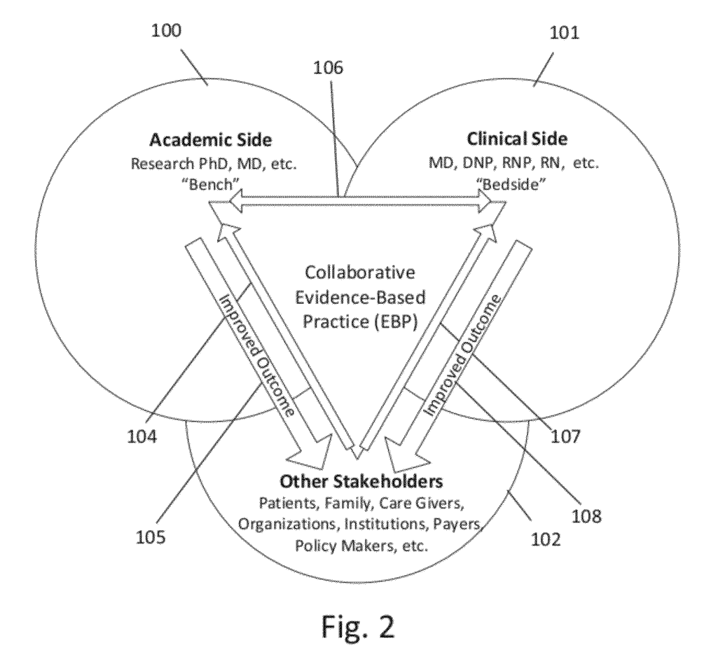

The present invention addresses the limitations if the prior art discussed above and enables a novel, new model for delivering healthcare known as “collaborative evidence-based practice.” More specifically, as shown in FIG. 2, constituents of the academic side 100 remain the sole drivers of new or revised medical treatment guidelines resulting in improved healthcare outcomes 105. As in the prior art, constituents of the academic side 100 still unilaterally collect observational data 104 from other healthcare delivery stakeholders 102 via the usual studies and surveys comporting with the scientific method. When interacting with constituents of the clinical side 101, however, a new collaborative pathway 106 exists in which constituents of the academic side 100 still unilaterally study and survey constituents of the clinical side 101. In addition though, constituents of the academic side 100 and clinical side 101 may now collaborate in real-time regarding the medical practice standards promulgated by constituents of the academic side 100 and utilized daily by constituents of the clinical side 101. This new collaborative pathway 106 gives constituents of the academic side 100 and constituents of the clinical side 101 a novel, new means to exchange information between themselves. Such information includes, but is not limited to, information provided by constituents of the clinical side 101 to constituents of the academic side 100 regarding: 1) the efficacy of incumbent medical treatment guidelines; 2) potential areas of investigation for subsequent guidelines; and, 3) the acceptance of particular guidelines by other stakeholders 102. Similarly, information provided by constituents of the academic side 100 to constituents of the clinical side 101 may encompass: 1) the best practices to be used when implementing incumbent medical treatment guidelines; 2) requests for potential areas of investigation to include and exclude when promulgating subsequent guidelines; and, 3) assessing the acceptance of particular guidelines by other stakeholders 102.

Moreover, the present invention provides a pathway 107 which gives constituents of the clinical side 101 a novel, new means to monitor real-time commentary provided by other healthcare ecosystem stakeholders 102. Such commentary includes, but is not limited to, information provided by other healthcare system stakeholders 102 to constituents of the clinical side 101 regarding: 1) the efficacy of incumbent medical treatment guidelines; 2) potential areas of investigation for subsequent guidelines; and, 3) the acceptance of particular guidelines by other stakeholders 102. Constituents on the clinical side 101 thus have a novel, new means of accessing information from other healthcare ecosystem stakeholders 102 thus informing more insightful interaction with constituents of the academic side 100 by means of a collaborative pathway 106. Similarly, by better understanding the practical ramifications of the medical practice guidelines they implement from the point of view of other healthcare ecosystem stakeholders 102, constituents of the clinical side 101 may unilaterally fashion more effective means of implementing the guidelines they apply, thus driving incrementally improved patient outcomes 108.

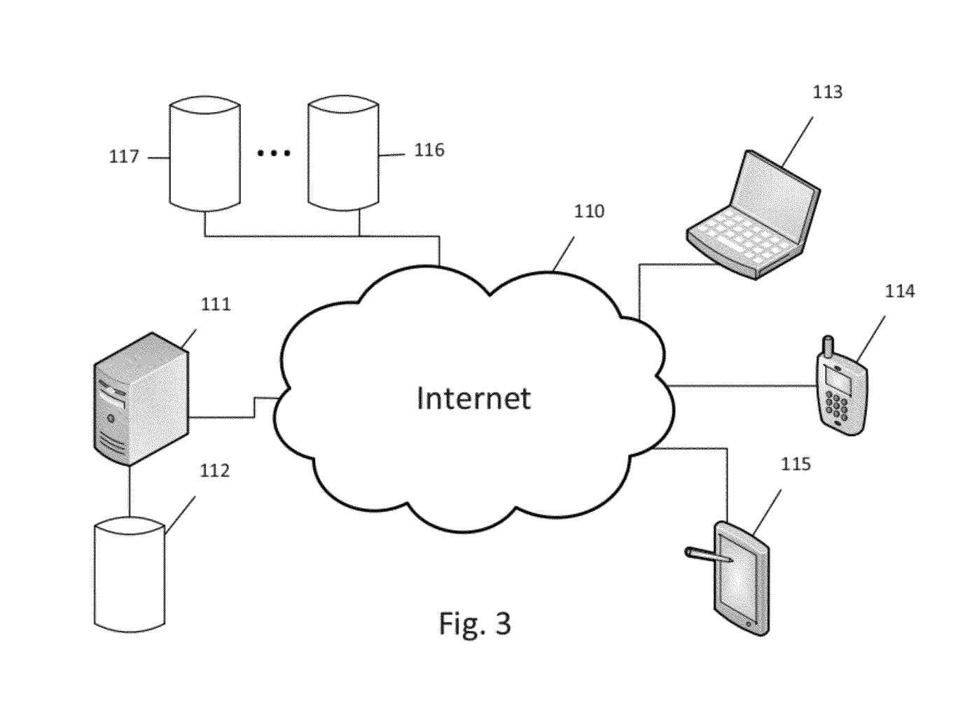

FIG. 3 illustrates a system for automatically integrating real-time, ad-hoc, community generated commentary including comments, notes, observations, and anecdotal data with a specific medical treatment guideline to generate a display containing both the guideline and the commentary. The network employs a server 111, such as a web-server, with an associated database 112 for storing real-time, ad-hoc, community generated commentary including comments, notes, observations, and anecdotal data and medical treatment guidelines. This server 111 is attached to a network 110, such as the Internet.

In a setup phase, server 111 accesses and downloads a multiplicity of medical practice guidelines available from a multiplicity of web-servers 116 through 117 and stores them with identifying data in database 112. Such medical treatment guidelines are available from a host of public web-sites, including, for example, the repository of medical treatment guidelines available at www.guideline.gov. Next, users employing a multiplicity of various terminal devices such as a computers 113, smartphones 114, and/or tablets 115 connect to, and interact with, server 111 to create account profiles which, among other things, contain the identity and contact information associated with each particular user. Finally, users employing a multiplicity of various terminal devices such as a computers 113, smartphones 114, and/or tablets 115 connect to, and interact with, server 111 to create group profiles which, among other things, designate individual subscribers as members of group, for example as part of a research team, a member of a hospital staff, or member of a medical journal editorial board.

In its operational phase, users employing a multiplicity of various terminal devices such as a computers 113, smartphones 114, and/or tablets 115 connect to, and interact with, server 111 to access and display individual medical treatment guidelines using any ordinary interface, such as an HTML page displayed via a web-browser. Users employing ordinary, interactive means such as keystrokes, mouse movements, hand, or finger gestures interpreted and transmitted to server 111 by one or more computers 113, smartphones 114, and/or tablets 115 may create and/or edit real-time, ad-hoc, community generated commentary including comments, notes, observations, and anecdotal data regarding a particular medical treatment guideline. After creating and/or editing commentary regarding a particular medical treatment guideline, this commentary is supplemented with data identifying the user creating and/or editing the comment, permanently linked with the associated medical treatment guideline, and stored in the database 112. Similarly, users employing ordinary, interactive means such as keystrokes, mouse movements, hand, or finger gestures interpreted and transmitted to server 111 by one or more computers 113, smartphones 114, and/or tablets 115 may upload documents, or video, or audio files into database 112 and incorporate these uploaded documents, or video, or audio files in any subsequent commentary that they author.

In a periodic maintenance phase, server 111 accesses and downloads a multiplicity of medical practice guidelines available from a multiplicity of web-servers 116 through 117 to determine if new guidelines have been published. If so, server 111 stores newly published medical treatment guidelines with identifying data in database 112. Server 111 then reverts to the operational phase described above.

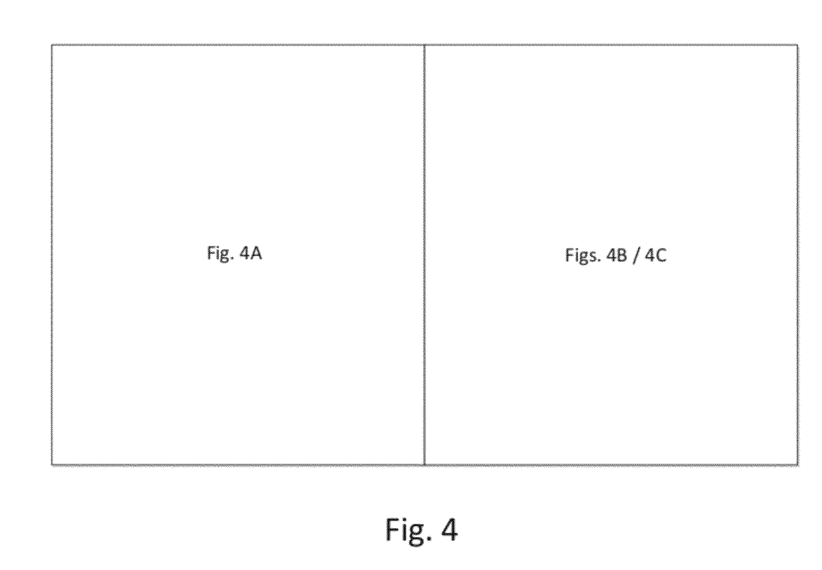

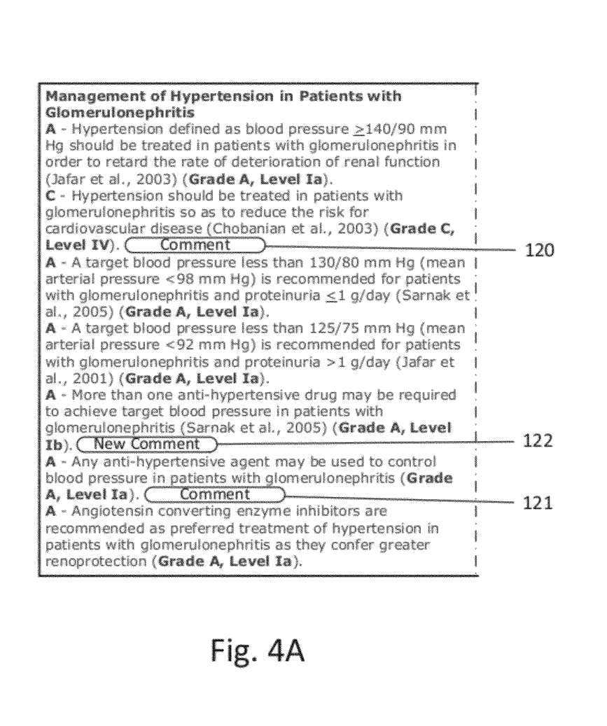

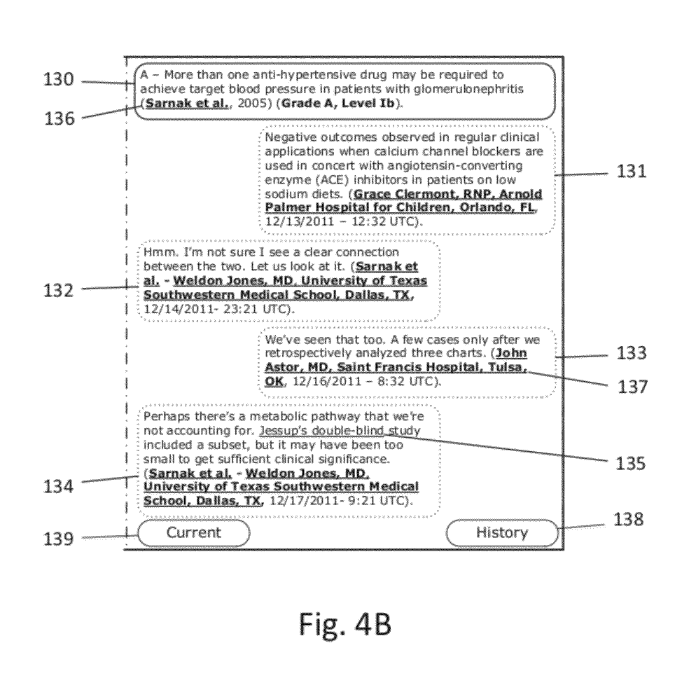

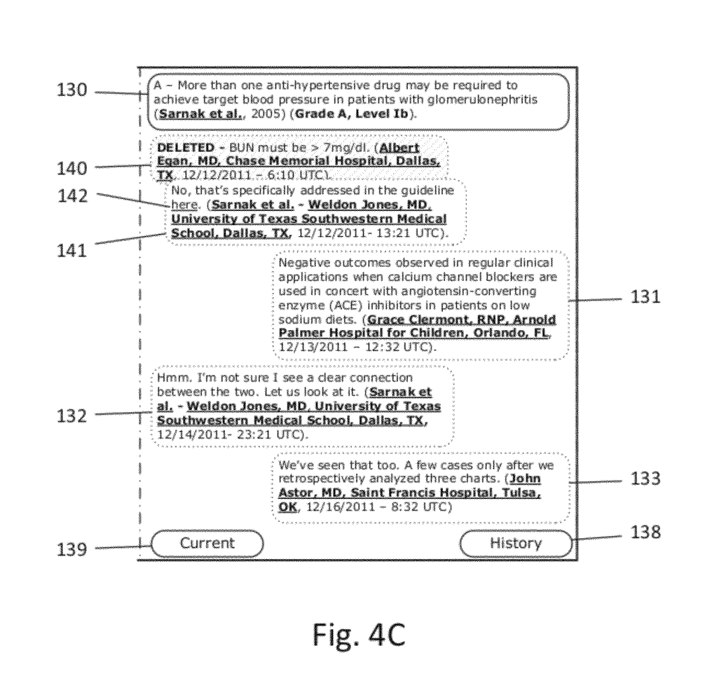

FIGS. 3 and 4 illustrate the manner in which an example of a system and method according to an embodiment of the present invention operates. Specifically, after medical treatment guidelines and at least one piece of real-time, ad-hoc, community generated commentary including comments, notes, observations, and anecdotal data regarding a particular medical treatment guideline, have been entered into database 112 in any of the manners described above, a user may access server 111 and its attached database 112 via a network, such as the Internet 110, using for example, a tablet computer 115 to generate a display on its display screen as shown in FIG. 4. In the example shown in FIG. 4A, the user has selected a portion of a medical practice guideline dealing with the treatment of hypertension in patients with glomerulonephritis. The user determines by means of highlighted buttons those elements of the guideline that are presently the subject of older, un-updated commentary (elements 120 and 121) and those elements of the guideline that are presently the subject of new, contemporaneous commentary (element 122). In this example, the user clicks or otherwise designates the button associated with element 122 thus dynamically generating that portion of the display portrayed in FIG. 4B. In this particular example, the medical treatment guideline selected by clicking the button associated with element 122, is redisplayed at the top of the right portion of the display in box 130. Arranged below the medical treatment guideline displayed in box 130, is a first comment, shown here in box 131. Second and subsequent comments are shown in boxes 132, 133, and 134, respectively. Ordinarily, comments are sorted and displayed with the oldest comment shown first (as in box 131) and with newer comments shown afterwards (as in box 134). From time-to-time however, other sort orders and arrangements, such as newest first to oldest last. may be preferable. As show by 137, each comment designates the identity of the contributor, the institutional affiliation of the contributor (if any), and the date and time that the commentary was authored. When comments (or original works) are attributable to a group of individuals (as exemplified by 136) they are so designated. References to uploaded documents or video or audio files may be included in a particular comment and are exemplified by 135.

Continuing further with this example, the user clicks or otherwise designates button 138 in FIG. 4B, thus dynamically generating that portion of the display portrayed in FIG. 4C. In this “historic” view all commentary, whether entered and unedited, entered and edited, and entered and deleted is shown. In this particular example, the medical treatment guideline selected by clicking the button associated with element 122, is redisplayed at the top of the right portion of the display in box 130. Arranged below the medical treatment guideline displayed in box 130, is a first comment, shown here in box 140. Second and subsequent comments are shown in boxes 131, 132, and 133 respectively. In this historic view all community supplied comments are displayed, including as shown in box 140, comments that have been deleted. If a community supplied comment is deleted, the user deleting the comment is required to supply a reason for deleting the comment as shown in box 141. References to uploaded documents or video or audio files, or other portions of the current or another medical treatment guideline may be included when articulating a reason for the deletion and is exemplified by hyperlink 142. Also, in this historic view community supplied comments that have been edited are displayed. If a community supplied comment is edited, the user editing the comment is required to supply a reason for the change. References to uploaded documents or video or audio files, or other portions of the current or another medical treatment guideline may be included when articulating a reason for the change. Continuing further with this example, the user clicks or otherwise designates button 139 in FIG. 4C, thus dynamically generating that portion of the display portrayed in FIG. 4B.

Although only a few exemplary embodiments of the invention have been described in detail above, those skilled in the art will readily appreciate that numerous modifications are possible in the exemplary embodiments. Accordingly, all such modifications are intended to be included within the scope of this invention as defined in the following claims.

What is claimed is:

1. A system for integrating medical treatment guidelines with ad-hoc, community generated commentary, comprising:
a data storage component, adapted to store medical treatment guideline data representing at least one medical treatment guideline for assessing and treating a condition of an entity, and ad-hoc community generated commentary representing at least one comment to be associated with said medical treatment guideline; and
an output device adapted to output at least one diagram representing said medical treatment guideline data, said diagram including at least one component representing a relationship of at least a portion of said medical treatment guideline to said ad-hoc community generated commentary representing at least one comment.

2. A system as claimed in claim 1, wherein:
said output device includes a display adapted to display said diagram.

3. A system as claimed in claim 1, wherein:
said entity is a person, said medical treatment guideline data represents medical information, and said ad-hoc community generated commentary represents recorded comments in a human perceptible form.

4. A system as claimed in claim 1, wherein:
said output device is further adapted to generate an output which is separate from said diagram and includes information determined from said relationship of at least a portion of said ad-hoc community generated commentary to at least a portion of said medical treatment guideline data.

5. A system as claimed in claim 1, further comprising:
at least one database input, adapted to input one of said medical treatment guideline data and one of said ad-hoc community generated commentary into said database.

6. A method for integrating medical treatment guidelines with ad-hoc community generated commentary, comprising:
storing medical treatment guideline data representing one medical treatment guideline for assessing and treating an entity;
storing ad-hoc community generated commentary representing at least one comment to be associated with said medical treatment guideline;
outputting at least one diagram representing said medical treatment guideline data, said diagram including at least one component representing a relationship of at least a portion of said ad-hoc community generated commentary to said medical treatment guideline data.

7. A method as claimed in claim 6, wherein:
said outputting includes displaying said diagram.

8. A method as claimed in claim 6, wherein:
said entity is a person, said medical treatment guideline data represents medical information, and said ad-hoc community generated commentary represents recorded comments in a human perceptible form.

9. A method as claimed in claim 6 further comprising:
generating an output which is separate from said diagram and includes information determined from said relationship of at least a portion of said ad-hoc community generated commentary to at least a portion of said medical treatment guideline data.

10. A method as claimed in claim 6, further comprising:
inputting one of said medical treatment guideline data and one of said ad-hoc community generated commentary for storage by said storing.

11. A computer-readable medium of instructions adapted to control a system to integrate medical treatment guidelines with comments, comprising:
a first set of instruction, adapted to control said system to store medical treatment guideline data representing at least one medical treatment guideline for assessing and treating the condition of an entity;
a second set of instructions adapted to control said system to store ad-hoc community generated commentary; and
a third set of instructions adapted to control said system to output at least one diagram representing said medical treatment guideline data, said diagram including at least one component representing a relationship of at least a portion of said ad-hoc community generated commentary to said medical treatment guideline data.

12. A computer readable medium of instructions as claimed in claim 11, wherein:
said third set of instructions is adapted to control said system to output said diagram by displaying said diagram on a display.
